(19) United States
(12) Patent Application Publication
(10) Pub. No.: US 2015/0045500 A1
(43) Pub. Date: Feb. 12, 2015

(54) PROCESS FOR PREPARATION OF AMINOPLAST SOLUTIONS

(71) Applicant: BASF SE, Ludwigshafen (DE)

(72) Inventors: Michael FINKENAUER, Worms (DE); Evelyn Fuchs, Mannheim (DE); Ralph Lunkwitz, Neustadt (DE); Oliver Reese, Mannheim (DE); Konrad Roschmann, Ladenburg (DE); Michael Schmidt, Dudenhofen (DE); Martin Reif, Römerberg (DE); Stephan Weinkötz, Neustadt (DE)

(73) Assignee: BASF SE

(21) Appl. No.: 14/451,948

(22) Filed: Aug. 5, 2014

(30) Foreign Application Priority Data
Aug. 6, 2013 (EP) 13179363.0

(51) Int. Cl. C08G 12/12; C08J 5/00; C09J 161/24

(52) U.S. Cl. CPC C08G 12/12; C09J 161/24; C08J 5/005; C08J 2361/24
USPC 524/597; 528/259

(57) ABSTRACT

The present invention relates to processes for discontinuously or continuously preparing aminoplast solutions by condensation of aminoplast formers with formaldehyde in a serial cascade of at least three stirred tank apparatus A, B, and C, which involves
a) in apparatus A, reacting a mixture comprising formaldehyde and urea in a molar ratio of 2.3:1 to 2.9:1 and water at a pH of 6 to 8, set by means of a base, at a temperature of 80 to 85° C., where apparatus A consists of one or more, i.e., one to ten, preferably one to five, more preferably one to three, more particularly one or two stirred tanks in parallel or in series, very preferably of one stirred tank,
b) in apparatus B, reacting said mixture at a molar ratio of formaldehyde to urea of 1.9:1 to 2.6:1, where apparatus B consists of one or more stirred tanks, wherein the molar ratio of formaldehyde to urea is lowered, optionally by further addition of urea, in stages to not less than 1.9:1, at a pH of 3.5 to 5.5, which is kept virtually constant, at a temperature of 100 to 105° C., and with a mean residence time of 10 to 90 minutes in the entire apparatus B,
c) in apparatus C, at a temperature of 90 to 100° C., raising the pH to at least 5.9 and lowering the molar ratio of formaldehyde to urea to 1.7:1 to 1.4:1, where apparatus C consists of one or more stirred tanks, and
d) by adding urea, at temperatures of 15 to 100° C., setting a final molar ratio of formaldehyde to urea of 0.7:1 to 1.28:1 and a pH of at least 7.

The present invention relates to a process for the discontinuous or continuous preparation of aminoplast solutions from formaldehyde and aminoplast formers in a cascade of at least three stirred tanks under specific conditions in the first and second tanks.

Known from DE-A-21 09 754 is a process for continuously preparing aminoplast solutions from formaldehyde and aminoplast formers, more particularly urea, in at least three stirred tanks in series, at elevated temperature and involving changing the molar ratio of the reaction components to one another a number of times. The catalyst mixture here consists of amine and acid and is supplied to the first reaction tank, where a temperature of approximately 95° C. becomes established. In this process it is important for the pH that prevails in each subsequent stirred tank to be significantly lower than in the preceding stirred tank, in order in this way to set uniform crosslinking rates that are sharply higher from tank to tank. These sharp increases in the condensation rate make it difficult to stop the reaction at a defined degree of condensation; especially if relatively high molar masses are desirable as a measure for a higher degree of condensation, the risk exists of complete polymerization within the reactor, entailing a dropout in production and a high level of cost and work for cleaning.

It was an object of the present invention, therefore, to remedy the aforementioned disadvantages, and more particularly to find a continuous process with which aminoplast solutions with relatively high degrees of condensation can be produced in a controlled way and with consistent quality.

Found accordingly has been a new and improved process for continuously preparing aminoplast solutions by discontinuous or continuous, preferably continuous condensation of aminoplast formers with formaldehyde in a serial cascade of at least three stirred tank apparatus A, B, and C, said process comprising
a) in apparatus A, reacting a mixture comprising formaldehyde and urea in a molar ratio of 2.3:1 to 2.9:1 and water at a pH of 6 to 8, set by means of a base, at a temperature of 80 to 85° C., where apparatus A consists of one or more, i.e., one to ten, preferably one to five, more preferably one to three, more particularly one or two stirred tanks in parallel or in series, very preferably of one stirred tank,
b) in apparatus B, reacting said mixture at a molar ratio of formaldehyde to urea of 1.9:1 to 2.6:1, where apparatus B consists of one or more stirred tanks, wherein the molar ratio of formaldehyde to urea is lowered, optionally by further addition of urea, in stages to not less than 1.9:1, at a pH of 3.5 to 5.5, which is kept virtually constant, at a temperature of 100 to 105° C., and with a mean residence time of 10 to 90 minutes in the entire apparatus B,
c) in apparatus C, at a temperature of 90 to 100° C., raising the pH to at least 5.9 and lowering the molar ratio of formaldehyde to urea to 1.7:1 to 1.4:1, where apparatus C consists of one or more stirred tanks, and
d) by adding urea, at temperatures of 15 to 100° C., setting a final molar ratio of formaldehyde to urea of 0.7:1 to 1.28:1 and a pH of at least 7.

The process of the invention may be carried out as follows:

In apparatus A, a mixture comprising formaldehyde and urea in a molar ratio of 2.3:1 to 2.9:1 and water can be reacted at a temperature of 80 to 85° C. and at a pH of 6 to 8, preferably 6.3 to 7.3, in one or more stirred tanks in parallel or in series, where the weight ratio of (formaldehyde+urea) to water can be varied in general within wide limits and in general is 0.2:1 to 1.8:1, preferably 0.5:1 to 1.5:1, more preferably 0.8:1 to 1.3:1. The pH may be set by means of a base. Apparatus A may consist of one or more stirred tanks in parallel or in series, as for example one to ten stirred tanks in parallel or in series, preferably one to five stirred tanks in parallel or in series, more preferably one to three stirred tanks in parallel or in series, more particularly one or two stirred tanks in parallel or in series, and very preferably of one stirred tank.

Discontinuously, preferably continuously, the reaction mixture can be transferred from apparatus A into apparatus B and the molar ratio of formaldehyde to urea can be set at 1.9:1 to 2.6:1. The setting of the molar ratio may take place in one or more stages, by addition of urea in solid or dissolved form. The reaction is carried out in general at a temperature of 100 to 105° C. and at a pH of 3.5 to 5.5, preferably 3.9 to 4.8, and a residence time of 10 to 90 minutes in one or more stirred tanks in parallel or in series; the pH should be kept virtually constant, in other words within a fluctuation range of ±0.3, preferably ±0.2, more preferably ±0.15. The pH may be set by means of an acid. Apparatus B may consist of one or more stirred tanks in parallel or in series, as for example one to fifteen stirred tanks in parallel or in series, preferably one to eight stirred tanks in parallel or in series, more preferably one to six stirred tanks in parallel or in series, more particularly one to five stirred tanks in parallel or in series, very preferably three to five stirred tanks in parallel or, preferably, in series.

Discontinuously, preferably continuously, the reaction mixture can be transferred from apparatus B into apparatus C and the molar ratio of formaldehyde to urea can be lowered to 1.7:1 to 1.4:1. The setting of the molar ratio may take place in one or more stages by addition of urea in solid or dissolved form. The reaction is carried out in general at a temperature of 90 to 100° C., preferably 93 to 98° C., and at a pH of at least 5.9, i.e., 5.9 to 7.5, preferably 6.0 to 6.7, in one or more stirred tanks in parallel or in series. Apparatus C may consist of one or more, i.e., one to ten, preferably one to five, more preferably one to three, more particularly one or two stirred tanks in parallel or in series, very preferably of one stirred tank.

Subsequently, by addition of urea, at temperatures of 15 to 100° C., preferably 40 to 95° C., a final molar ratio of formaldehyde to urea of 0.7:1 to 1.28:1 can be set, and, by addition of a base, a pH of at least 7 can be set, i.e., 7 to 10, preferably 7.5 to 9.5. Optionally there may be distillative concentration, optionally under reduced pressure, to final viscosities of 250 to 700 mPas.

The urea-formaldehyde resins prepared in accordance with the invention generally feature a dispersity (=weight average M_{w} of the molar mass/number average Mₙ of the molar mass) of 20 to 80, preferably of 25 to 70, more preferably of 30 to 60.

The process of the invention, preferably process stages a), b), c), and d), is/are carried out generally under a pressure of 0.3 to 3 bar, preferably 0.5 to 2 bar, more preferably at 0.8 to 1.2, more particularly under atmospheric pressure (standard pressure).

The urea may be used both in the form of solid urea and, preferably, as urea solution. The urea solutions comprise urea in suitable solvents. Suitable solvents are water, alcohols such as methanol or ethanol, glycerol or mixtures thereof, preferably water or water/alcohol mixtures, more preferably water.

The concentration of the urea in solution may vary within wide ranges and is generally 30 to 85 wt %, preferably 40 to 80 wt %, more preferably 50 to 70 wt %.

The urea solutions are generally aqueous solutions in a concentration range of 30 to 85 wt %, preferably 40 to 80 wt %, more preferably 50 to 70 wt %.

Formaldehyde may be used both in the form of paraformaldehyde and, preferably, in the form of formaldehyde solution. The formaldehyde solutions comprise formaldehyde in suitable solvents. Suitable solvents are water or alcohols such as methanol or ethanol or mixtures thereof, preferably water and water/alcohol mixtures, more preferably water.

The concentration of the formaldehyde in solution may vary within wide ranges and is generally 5 to 70 wt %, preferably 30 to 60 wt %, more preferably 40 to 50 wt %.

The formaldehyde solutions are generally aqueous solutions in a concentration range from 5 to 70 wt %, preferably 30 to 60 wt %, more preferably 40 to 50 wt %.

Formaldehyde and urea may also be employed at least partly in the form of aqueous formaldehyde-urea solutions and/or aqueous formaldehyde-urea precondensates.

In one preferred embodiment of the process of the invention, apparatus B consists of at least two stirred tanks, the molar ratio of formaldehyde to urea in the first tank of apparatus B being 2.6:1 to 2.25:1 and then being lowered in a further tank of apparatus B, by addition of urea in solid or dissolved form, to 2.2:1 to 1.9:1.

In another preferred embodiment of the process of the invention, apparatus B consists of at least three stirred tanks, the molar ratio of formaldehyde to urea in the first tank of apparatus B being 2.6:1 to 2.3:1, being lowered in a further tank of apparatus B, by addition of urea in solid or dissolved form, to 2.25:1 to 2.1:1, and being lowered in turn in a further tank of apparatus B to 2.05:1 to 1.9:1.

In another preferred embodiment of the process of the invention, the addition of urea in d) takes place in two or more steps.

In another preferred embodiment, the urea-formaldehyde resin solution is distilled before the final addition of urea and hence before the setting of the final molar ratio in d).

In one particularly preferred embodiment of the process of the invention, the amount of the addition of acid in apparatus B is selected such that the urea-formaldehyde resins prepared in the solution have a weight-average molecular weight M_{w} of 15,000 to 50,000 g/mol, preferably 17,000 to 40,000 g/mol, more preferably 18,000 to 36,000 g/mol. For this purpose, samples of the freshly prepared urea-formaldehyde resins can be analyzed by means of gel permeation chromatography (GPC) and the amount in which the acid is added in apparatus B can be adapted such that the weight-average molecular weight M_{w} is within the desired range. If M_{w} is below the desired range, the amount of acid added is raised, with virtually the same residence time, in apparatus B; if M_{w} is above the desired range, the amount of acid added is lowered, with virtually the same residence time in apparatus B.

The average molar masses reported here were determined as follows:

Size exclusion chromatography

Eluent: hexafluoroisopropanol+0.05% potassium trifluoroacetate

Column temperature: 40° C.

Flow rate: 1 mL/min

Injection: 50 μL

Concentration: 1.5 mg/mL

The sample solutions were filtered through Millipore Millex FG (0.2 μm).

Separating column combination:

| Columns | | | | |
|---|---|---|---|---|
| | i.d. | Length | | |
| No. | mm | cm | Separation material | Column name |
| 1039 | 8 | 5 | | HFIP-LG Guard |
| 632 | 7.5 | 30 | Styrene- | PL HFIPGel |
| | | | divinylbenzene | |
| 1321 | 7.5 | 30 | SDV | PL HFIPgel |

Number of theoretical plates of the combination at the stated flow rate: 20,000. Detector: DRI Agilent 1100

Calibration took place with narrow-range PMMA standards from PSS with molecular weights of M=800 to M=1,820,000. The values outside this elution range were extrapolated.

Evaluation took place to a molar mass of greater than or equal to about 124 g/mol (19.98 ml).

Suitable bases are inorganic bases such as hydroxides, examples being alkali metal and alkaline earth metal hydroxides such as lithium hydroxide, sodium hydroxide, potassium hydroxide, magnesium hydroxide, calcium hydroxide, barium hydroxide, or carbonates, examples being sodium carbonate, magnesium carbonate, calcium carbonate, or mixtures thereof, preferably lithium hydroxide, sodium hydroxide, potassium hydroxide, magnesium hydroxide, calcium hydroxide or mixtures thereof, more preferably sodium hydroxide in solid or liquid form. Hydroxides in liquid form are generally aqueous or alcoholic solutions with strengths of 0.01 to 99.9 wt %, preferably aqueous solutions with strengths of 5 to 50 wt %.

Suitable acids are inorganic acid such as nitric acid, phosphoric acid, hydrochloric acid, or sulfuric acid, and organic acids, examples being formic acid, acetic acid, oxalic acid, maleic acid, or acidic salts; preferably organic acids such as formic acid, acetic acid, oxalic acid, maleic acid, or acidic salts, and more preferably formic acid.

The acids are employed generally in the form of aqueous solutions, preferably as solutions with a strength of 0.1-30 wt %.

The resins prepared in accordance with the invention may be blended optionally prior to use with urea-formaldehyde condensation products which have a weight ratio of formaldehyde to urea of 0.85:1 to 2:1, and/or with urea in solid form or in aqueous solution. Blending is generally carried out with urea-formaldehyde condensation products, advantageously in a weight ratio of resin prepared in accordance with the invention to urea-formaldehyde condensation products of 99:1 to 10:90, more particularly 95:5 to 50:50. Blending with urea takes place in general in a ratio of resin prepared in accordance with the invention to urea or urea solution in a ratio of 99:1 to 70:30, more particularly 98:2 to 80:20.

The solids content of the resins prepared in accordance with the invention is generally 50 to 80 wt %, preferably 60 to 70 wt %. The solids content may be determined by weighing out liquid resin (e.g., 1 g) into a flat metal boat and then drying it at 120° C. for two hours and weighing again (M. Dunky, P. Niemz, Holzwerkstoffe und Leime, Springer, Berlin, 2002, page 458).

Further additives may be incorporated into these resins, in amounts of up to 20 wt %, i.e., 0 to 20 wt %, preferably 0 to 10 wt %. These additives may be, for example, alcohols such as ethylene glycol, diethylene glycol, or saccharides. Use may also be made of water-soluble polymers based on acrylamide, ethylene oxide, N-vinylpyrrolidone, vinyl acetate, and copolymers with these monomers. The resins may be admixed with fillers, such as, for example, cellulosic fibers, or mixtures thereof. They may also comprise carbonates, hydrogencarbonates, sulfites, hydrogensulfites, disulfites, phosphates, hydrogen phosphates, or mixtures thereof.

The resins of the invention are generally stable on storage at 20° C. for a number of weeks.

The resins of the invention possess suitability as binders, more particularly for producing lignocellulosic moldings such as, for example, panels of chipboard, fiberboard, or oriented strand board (OSB). The mixtures of the invention are suitable, furthermore, for the sheetlike gluing of wood, such as in order, for example, to produce plywood, single-layer and multilayer boards, and glued laminated timber. The resins of the invention are especially suitable for producing fiberboard panels, preferably MDF or medium-density fiberboard and HDF or high-density fiberboard panels, especially when gluing takes place in the blowline. In the blowline process, the resin is injected into the fiber stream, which is moving at high velocity, after the defibration of the wood in the refiner. The resinated fibers are subsequently dried (M. Dunky, P. Niemz, Holzwerkstoffe und Leime, Springer, Berlin, 2002, page 145).

Reactivity of the binder mixtures on curing can be enhanced by further admixing them immediately prior to processing with a curing agent such as, for example, ammonium salts such as ammonium chloride, ammonium sulfate, ammonium nitrate, ammonium phosphates, or carboxylic acids such as formic acid and oxalic acid, or Lewis acids such as aluminum chloride, or acidic salts such as aluminum sulfate, or mineral acids such as sulfuric acid, or mixtures thereof. The curing agents can be mixed with the aqueous binder (“glue liquor”) and then sprayed, for example, onto chips or fibers, or the curing agents may be applied to the substrate separately from the binder.

The lignocellulosic moldings of the invention, such as chipboard, OSB, or fiberboard panels, can be produced, for example, by pressing 5 to 30 wt % of solid resin, relative to lignocellulosic material, under pressure at press temperatures from 120 to 250° C. Curing agents, as described above, may additionally be used. Under these conditions, the aminoplast resin generally cures rapidly, and woodbase materials are obtained which feature good mechanical properties and low formaldehyde emission.

### EXAMPLES

### Example 1

Preparation of Glue 1

By means of continuous metering, 7.16 parts by weight of an aqueous 49% strength formaldehyde solution, 3.96 parts by weight of an aqueous 68% strength urea solution, and one part by weight of water were introduced per hour into the first tank (A1) of a cascade consisting of six stirred tanks, and a pH of 6.7 was set by addition of 25% strength aqueous NaOH solution. Metered hourly into the second tank (B1) of the stirred tank cascade was 0.52 part by weight of an aqueous 68% strength urea solution. The pH is set at 4.2-4.3 by addition of 10% strength aqueous formic acid solution. Added hourly in the third tank (B2) was 0.43 part by weight of an aqueous 68% strength urea solution. Without further change in the molar ratio (formaldehyde:urea) and with a virtually constant pH, the reaction mixture was transferred via the fourth (B3) and fifth (B4) tanks into the 6th tank. In the 6th stirred tank (C1), 1.74 parts by weight per hour of an aqueous 68% strength urea solution were metered in. The pH was set at 6.5 by addition of 25% strength aqueous NaOH solution.

The temperatures in the individual tanks were as follows:

| Apparatus | A | B | | | | C |
|---|---|---|---|---|---|---|
| Tank | A1 | B1 | B2 | B3 | B4 | C1 |
| Temp. [° C.] | 82 | 102 | 103 | 102 | 102 | 96 |

The resulting aminoplast solution was admixed with 3.75 parts by weight (per h) of aqueous 68% strength urea solution and evaporated down continuously under reduced pressure to a drymatter content of approximately 65%. Cooling took place to about 20° C., and a pH of 8.9 was set by addition of 25% strength aqueous NaOH solution.

This gave an aminoplast resin having the following properties:

Molar ratio (F/U): 0.99

Viscosity at 20° C. (shear rate 313 1/s): 394 mPas

Molar mass: weight average M_{w}=35 570 g/mol, dispersity M_{w}/Mₙ=49.6 (Mₙ=number average)

### Example 2

Preparation of Glue 2

By means of continuous metering, 10.0 parts by weight of an aqueous 49% strength formaldehyde solution and 5.52 parts by weight of an aqueous 68% strength urea solution were introduced per hour into the first tank (A1) of a cascade consisting of seven stirred tanks, and a pH of 6.7 was set by addition of 25% strength aqueous NaOH solution. Metered hourly into the second tank (B1) of the stirred tank cascade was 0.72 part by weight of an aqueous 68% strength urea solution. The pH was set at 4.5 by addition of 10% strength aqueous formic acid solution. Added hourly in the third tank (B2) was 0.59 part by weight of an aqueous 68% strength urea solution. Without further change in the molar ratio (formaldehyde:urea) and with a virtually constant pH, the reaction mixture was transferred via the fourth (B3) and fifth (B4) tanks into the 6th tank. In the 6th stirred tank (C1), 2.23 parts by weight per hour of an aqueous 68% strength urea solution were metered in. The pH was set at 6.7 by addition of 25% strength aqueous NaOH solution.

The temperatures in the individual tanks were as follows:

| Apparatus | A | B | | | | C | |
|---|---|---|---|---|---|---|---|
| Tank | A1 | B1 | B2 | B3 | B4 | C1 | C2 |
| Temp. | 82 | 102 | 103 | 102 | 102 | 96 | 96 |
| [° C.] | | | | | | | |

After passage through the seventh tank (C2), which occurred without further change in molar ratio or pH, the resulting aminoplast solution was admixed with 3.26 parts by weight (per h) of aqueous 68% strength urea solution and evaporated down continuously under reduced pressure to a dry-matter content of approximately 64.5%. Cooling took place to about 20° C., and a pH of 8.4 was set by addition of 25% strength aqueous NaOH solution.

This gave an aminoplast resin having the following properties:

Molar ratio (F/U): 1.17

Viscosity at 20° C. (shear rate 313 1/s): 480 mPas

Molar mass: weight average M_{w}=21 160 g/mol, dispersity M_{w}/Mₙ=33.5 (Mₙ=number average)

### Example 3

Preparation of Glue 3

By means of continuous metering, 9.31 parts by weight of an aqueous 49% strength formaldehyde solution, 5.14 parts by weight of an aqueous 68% strength urea solution, and 1.3 parts by weight of water were introduced per hour into the first tank (A1) of a cascade consisting of six stirred tanks, and a pH of 6.9 was set by addition of 25% strength aqueous NaOH solution. Metered hourly into the second tank (B1) of the stirred tank cascade was 0.67 part by weight of an aqueous 68% strength urea solution. The pH was set at 4.4 by addition of 10% strength aqueous formic acid solution. Added hourly in the third tank (B2) was 0.55 part by weight of an aqueous 68% strength urea solution. Without further change in the molar ratio (formaldehyde:urea) and with a virtually constant pH, the reaction mixture was transferred via the fourth (B3) and fifth (B4) tanks into the 6th tank. In the 6th stirred tank (C1), 2.26 parts by weight per hour of an aqueous 68% strength urea solution were metered in. The pH was set at 6.5 by addition of 25% strength aqueous NaOH solution.

The temperatures in the individual tanks were as follows:

| Apparatus | A | B | | | | C |
|---|---|---|---|---|---|---|
| Tank | A1 | B1 | B2 | B3 | B4 | C1 |
| Temp. [° C.] | 82 | 102 | 103 | 102 | 102 | 96 |

The resulting aminoplast solution was admixed with 5.54 parts by weight (per h) of aqueous 68% strength urea solution and evaporated down continuously under reduced pressure to a drymatter content of approximately 65%. Cooling took place to about 20° C., and a pH of 8.3 was set by addition of 25% strength aqueous NaOH solution.

This gave an aminoplast resin having the following properties:

Molar ratio (F/U): 0.95

Viscosity at 20° C. (shear rate 313 1/s): 341 mPas

Molar mass: weight average M_{w}=27 430 g/mol, dispersity M_{w}/Mₙ=40.9 (Mₙ=number average)

### Example 4

Preparation of Glue 4

By means of continuous metering, 16.82 parts by weight of an aqueous 49% strength formaldehyde solution, 9.29 parts by weight of an aqueous 68% strength urea solution, and 2.35 parts by weight of water were introduced per hour into the first tank (A1) of a cascade consisting of six stirred tanks, and a pH of 6.7 was set by addition of 25% strength aqueous NaOH solution. Metered hourly into the second tank (B1) of the stirred tank cascade were 1.21 parts by weight of an aqueous 68% strength urea solution. The pH was set at 4.2-4.3 by addition of 10% strength aqueous formic acid solution. Added hourly in the third tank (B2) was one part by weight of an aqueous 68% strength urea solution. Without further change in the molar ratio (formaldehyde:urea) and with a virtually constant pH, the reaction mixture was transferred via the fourth (B3) and fifth (B4) tanks into the 6th tank. In the 6th stirred tank (C1), 4.08 parts by weight per hour of an aqueous 68% strength urea solution were metered in. The pH was set at 6.5 by addition of 25% strength aqueous NaOH solution.

The temperatures in the individual tanks were as follows:

| Apparatus | A | B | | | | C |
|---|---|---|---|---|---|---|
| Tank | A1 | B1 | B2 | B3 | B4 | C1 |
| Temp. [° C.] | 83 | 102 | 103 | 102 | 102 | 96 |

The resulting aminoplast solution was admixed with 7.70 parts by weight (per h) of aqueous 68% strength urea solution and evaporated down continuously under reduced pressure to a drymatter content of approximately 64%. Cooling took place to about 20° C., and a pH of 9.5 was set by addition of 25% strength aqueous NaOH solution.

This gave an aminoplast resin having the following properties:

Molar ratio (F/U): 1.04

Viscosity at 20° C. (shear rate 313 1/s): 425 mPas

Molar mass: weight average M_{w}=33 910 g/mol, dispersity M_{w}/Mₙ=52.7 (Mₙ=number average)

### Example 5

Preparation of Glue 5

By means of continuous metering, 13.80 parts by weight of an aqueous 49% strength formaldehyde solution, 7.62 parts by weight of an aqueous 68% strength urea solution, and 1.93 parts by weight of water were introduced per hour into the first tank (A1) of a cascade consisting of seven stirred tanks, and a pH of 6.7 was set by addition of 25% strength aqueous NaOH solution. Metered hourly into the second tank (B1) of the stirred tank cascade was one part by weight of an aqueous 68% strength urea solution. The pH was set at 4.2-4.3 by addition of 10% strength aqueous formic acid solution. Added hourly in the third tank (B2) was 0.82 part by weight of an aqueous 68% strength urea solution. Without further change in the molar ratio (formaldehyde:urea) and with a virtually constant pH, the reaction mixture was transferred via the fourth (B3), fifth (B4), and sixth (B5) tanks into the 7th tank. In the 7th stirred tank (C1), 3.34 parts by weight per hour of an aqueous 68% strength urea solution were metered in. The pH was set at 6.3 by addition of 25% strength aqueous NaOH solution.

The temperatures in the individual tanks were as follows:

| Apparatus | A | B | | | | | C |
|---|---|---|---|---|---|---|---|
| Tank | A1 | B1 | B2 | B3 | B4 | B5 | C1 |
| Temp. | 82 | 102 ± 1 | | | | | 96 |
| [° C.] | | | | | | | |

The resulting aminoplast solution was admixed with 7.12 parts by weight (per h) of aqueous 68% strength urea solution and evaporated down continuously under reduced pressure to a drymatter content of approximately 63.5%. Cooling took place to about 20° C., and a pH of 9.3 was set by addition of 25% strength aqueous NaOH solution.

This gave an aminoplast resin having the following properties:

Molar ratio (F/U): 1.00

Viscosity at 20° C. (shear rate 313 1/s): 377 mPas

Molar mass: weight average M_{w}=30 650 g/mol, dispersity M_{w}/Mₙ=42.9 (Mₙ=number average)

### Example 6

Preparation of Glue 6

By means of continuous metering, 4.93 parts by weight of an aqueous 49% strength formaldehyde solution, 2.73 parts by weight of an aqueous 68% strength urea solution, and one part by weight of water were introduced per hour into the first tank (A1) of a cascade consisting of six stirred tanks, and a pH of 6.7 was set by addition of 25% strength aqueous NaOH solution. Metered hourly into the second tank (B1) of the stirred tank cascade was 0.36 part by weight of an aqueous 68% strength urea solution. The pH was set at 4.3-4.4 by addition of 10% strength aqueous formic acid solution. Added hourly in the third tank (B2) was 0.29 part by weight of an aqueous 68% strength urea solution. Without further change in the molar ratio (formaldehyde:urea) and with a virtually constant pH, the reaction mixture was transferred via the fourth (B3) and fifth (B4) tanks into the 6th tank. In the 6th stirred tank (C1), 1.20 parts by weight per hour of an aqueous 68% strength urea solution were metered in. The pH is set at 6.6-6.7 by addition of 25% strength aqueous NaOH solution.

The temperatures in the individual tanks are as follows:

| Apparatus | A | B | | | | C |
|---|---|---|---|---|---|---|
| Tank | A1 | B1 | B2 | B3 | B4 | C1 |
| Temp. | 82 | 102 | 103 | 102 | 102 | 96 |
| [° C.] | | | | | | |

The resulting aminoplast solution was admixed with 2.82 parts by weight (per h) of aqueous 68% strength urea solution and evaporated down continuously under reduced pressure to a drymatter content of approximately 66%. Cooling took place to about 20° C., and a pH of 9.4 was set by addition of 25% strength aqueous NaOH solution.

This gave an aminoplast resin having the following properties:

Molar ratio (F/U): 0.96

Viscosity at 20° C. (shear rate 313 1/s): 411 mPas

Molar mass: weight average M_{w}=26 600 g/mol, dispersity M_{w}/Mₙ=41.0 (Mₙ=number average)

Technical Performance Examples

General description of the production of woodbase materials (laboratory):

Production of Chipboard Panels

In a mixer, spruce chips (residual moisture content 2-4%) are mixed with glue, formaldehyde scavenger, emulsion, curing agent, and optionally PMDI. The proportions are selected so as to give the desired values for glue factor (i.e., ratio of the mass of glue dry matter to the mass of wood dry matter) and moisture content. The resinated chips are subsequently poured to form a three-layer chip cake (outer layer/middle layer/outer layer ratio by mass is approximately 17:66:17).

The chip cake is first subjected to cold precompaction and then to pressing in a heating press. After they have cooled, the resulting chipboard panels are trimmed, sanded, sawn down into test specimens, and tested.

Production of MDF/HDF Boards

First of all, chips (of spruce) are defibrated in a refiner. The fibers are subsequently dried in a stream dryer to a final moisture content of approximately 4%. In a mixer, the fibers are mixed with glue, formaldehyde scavenger, emulsion, and optionally curing agent. The proportions here are selected so as to give the desired values for glue factor (i.e., ratio of the mass of glue dry matter to the mass of wood dry matter) and moisture content. The resinated fibers are then poured to form a fiber cake.

This cake is first of all subjected to cold precompaction and then to pressing in a heating press. After cooling, the resulting fiberboard panels are trimmed, sanded, sawn down into test specimens, and tested.

### Abbreviations Used

AN ammonium nitrate

AS ammonium sulfate

atro dry mass of wood

OL outer layer

FA formaldehyde

SL solids

UR urea

Urso urea solution

ML middle layer

SR solid resin

Investigation of the Woodbase Materials

Density

The density was determined 24 hours after production, in accordance with EN 1058.

Transverse Tensile Strength

The transverse tensile strength was determined in accordance with EN 319.

Swelling Values

The swelling values were determined after 24 h water storage, in accordance with EN 317.

Formaldehyde Emission (Perforator Method)

The formaldehyde emission was determined in accordance with EN 120.

Formaldehyde emission (test chamber method)

The formaldehyde emission was determined in accordance with EN 717-1.

### Example 7

A glue produced according to example 6 was used for producing chipboard panels with a thickness of 17.7 mm and a density of 650 kg/m³ (pressing temperature 200° C., pressing factor 10 s/mm).

| | | Formaldehyde scavenger | | | | Curing agent | | | |
|---|---|---|---|---|---|---|---|---|---|
| Glue factor | | OL | | ML | | OL | | ML | |
| OL | ML | | Amount | | Amount | | Amount | | Amount |
| [% SL/atro] | [% SL/atro] | Type | [% SL/SR] | Type | [% SL/SR] | Type | [% SL/SR] | Type | [% SL/SR] |
| 12.00 | 8.80 | | | UR solid | 3.00 | AN 50% | 0.7 | AN 50% | 4.0 |

| PMDI | | Emulsion | | | | | |
|---|---|---|---|---|---|---|---|
| ML | | OL | | ML | | | |
| | Amount | | Amount | | Amount | Moisture content [%] | |
| Type | [% SL/atro] | Type | [% SL/atro] | Type | [% SL/atro] | OL | ML |
| Lupranat | 0.50 | Sasol Hydrowax | 0.7 | Sasol Hydrowax | 0.5 | 12 | 7 |
| M20FB | | 954 44% form | | 954 44% form | | | |

Test Results:

| Transverse | Swelling | Perforator | 1 m³ chamber |
|---|---|---|---|
| tensile | 24 h | (Formaldehyde emission) | (Formaldehyde emission) |
| [N/mm²] | [%] | [mg HCHO/100 g atro] | [ppm] |
| 0.48 | 13.80 | 2.3 | 0.042 |

### Example 8

A glue produced according to example 6 was used for producing HDF panels with a thickness of 7.4 mm and a density of 860 kg/m³ (pressing temperature 190° C., pressing factor 15 s/mm).

| | Formaldehyde | | | | | | |
|---|---|---|---|---|---|---|---|
| | scavenger | | Curing agent | | Emulsion | | Moisture |
| Glue factor | | Amount | | Amount | | Amount | content |
| [% SL/atro] | Type | [% SL/SR] | Type | [% SL/SR] | Type | [% SL/SR] | [%] |
| 13.1 | Urso | 2.7 | none | 0.0 | Sasol | 3.0 | 11 |
| | 40% | | | | Hydrowax | | |
| | | | | | 954 | | |
| | | | | | 44% form | | |

Test Results:

| Transverse | Swelling | Perforator | 1 m³ chamber |
|---|---|---|---|
| tensile | 24 h | (Formaldehyde emission) | (Formaldehyde emission) |
| [N/mm²] | [%] | [mg HCHO/100 g atro] | [ppm] |
| 1.88 | 13.60 | 6.6 | 0.084 |

### Example 9

A glue produced according to example 1 was used for producing MDF panels with a thickness of 18 mm and a density of 730 kg/m³ (pressing temperature 190° C., pressing factor 12 s/mm).

| | Formaldehyde | | | | | | |
|---|---|---|---|---|---|---|---|
| | scavenger | | Curing agent | | Emulsion | | Moisture |
| Glue factor | | Amount | | Amount | | Amount | content |
| [% SL/atro] | Type | [% SL/SR] | Type | [% SL/SR] | Type | [% SL/SR] | [%] |
| 14.0 | Urso | 2.0 | AS | 0.5 | Sasol | 0.5 | 11 |
| | 40% | | 40% | | Hydrowax | | |
| | | | | | 954 | | |
| | | | | | 44% form | | |

Test Results:

| Transverse | Swelling | Perforator | 1 m³ chamber |
|---|---|---|---|
| tensile | 24 h | (Formaldehyde emission) | (Formaldehyde emission) |
| [N/mm²] | [%] | [mg HCHO/100 g atro] | [ppm] |
| 0.95 | 17.40 | 7.1 | 0.068 |

### Example 10

A glue produced according to example 3 was used for producing HDF panels with a thickness of 2.9 mm and a density of 820 kg/m³ (pressing temperature 190° C., pressing factor 20 s/mm).

| | Formaldehyde | | | | | | |
|---|---|---|---|---|---|---|---|
| | scavenger | | Curing agent | | Emulsion | | Moisture |
| Glue factor | | Amount | | Amount | | Amount | content |
| [% SL/atro] | Type | [% SL/SR] | Type | [% SL/SR] | Type | [% SL/SR] | [%] |
| 11.5 | Urso | 9.20 | AS | 3.0 | Sasol | 0.3 | 11 |
| | 40% | | 40% | | Hydrowax | | |
| | | | | | 954 | | |
| | | | | | 44% form | | |

Test Results:

| Transverse | Perforator | 1 m³ chamber |
|---|---|---|
| tensile | (Formaldehyde emission) | (Formaldehyde emission) |
| [N/mm²] | [mg HCHO/100 g atro] | [ppm] |
| 1.28 | 3.8 | 0.042 |

### Example 11

A glue produced according to example 2 was used for producing chipboard panels with a thickness of 18.7 mm and a density of 650 kg/m³ (pressing temperature 200° C., pressing factor 10 s/mm).

| | | Formaldehyde scavenger | | | | Curing agent | | | |
|---|---|---|---|---|---|---|---|---|---|
| Glue factor | | OL | | ML | | OL | | ML | |
| OL | ML | | Amount | | Amount | | Amount | | Amount |
| [% SL/atro] | [% SL/atro] | Type | [% SL/FSR] | Type | [% SL/FSR] | Type | [% SL/FSR] | Type | [% SL/FSR] |
| 10.70 | 7.60 | Urso 40% | 2.80 | UR solid | 5.30 | AN 50% | 0.5 | AN 50% | 2.5 |

| Emulsion | |
|---|---|
| OL | ML |

| Type | Amount | Type | Amount | Moisture content [%] | |
|---|---|---|---|---|---|
| | [% SL/atro] | | [% SL/atro] | OL | ML |
| Sasol | 0.3 | Sasol | 0.3 | 12 | 7 |
| Hydrowax | | Hydrowax | | | |
| 954 | | 954 | | | |
| 44% form | | 44% form | | | |

Test Results:

| Transverse | Swelling | Perforator | 1 m³ chamber |
|---|---|---|---|
| tensile | 24 h | (Formaldehyde emission) | (Formaldehyde emission) |
| [N/mm²] | [%] | [mg HCHO/100 g atro] | [ppm] |
| 0.48 | 24.70 | 5.2 | 0.132 |

1-18. (canceled)

19. A process for preparing an aminoplast solution by discontinuous or continuous condensation of an aminoplast former with formaldehyde in a serial cascade of at least three stirred tank apparatus A, B, and C, said process comprising
a) in apparatus A, reacting a mixture comprising formaldehyde and urea in a molar ratio of 2.3:1 to 2.9:1 and water at a pH of 6 to 8, set by means of a base, at a temperature of 80 to 85° C., where apparatus A consists of one or more stirred tanks in parallel or in series,
b) in apparatus B, reacting said mixture at a molar ratio of formaldehyde to urea of 1.9:1 to 2.6:1, where apparatus B consists of one or more stirred tanks, wherein the molar ratio of formaldehyde to urea is lowered, optionally by further addition of urea, in stages to not less than 1.9:1, at a pH of 3.5 to 5.5, which is kept virtually constant, at a temperature of 100 to 105° C., and with a mean residence time of 10 to 90 minutes in the entire apparatus B,
c) in apparatus C, at a temperature of 90 to 100° C., raising the pH to at least 5.9 and lowering the molar ratio of formaldehyde to urea to 1.7:1 to 1.4:1, where apparatus C consists of one or more stirred tanks, and
d) by adding urea, at temperatures of 15 to 100° C., to a final molar ratio of formaldehyde to urea of 0.7:1 to 1.28:1 and a pH of at least 7.

20. The process for preparing an aminoplast solution according to claim 19, wherein the condensation of aminoplast formers with formaldehyde is carried out continuously in a cascade of stirred tanks in series.

21. The process for preparing an aminoplast solution according to claim 19, wherein the molar ratio between the mixture comprising formaldehyde and urea to water in apparatus A is 0.2:1 to 1.8:1.

22. The process for preparing an aminoplast solution according to claim 19, wherein the pH in apparatus B is kept virtually constant within a fluctuation range of ±0.3.

23. The process for preparing an aminoplast solution according to claim 19, wherein d) is followed by distillative concentration, optionally under reduced pressure, to a final viscosity of 250 to 700 mPas.

24. The process for preparing an aminoplast solution according to claim 19, which is carried out under a pressure of 0.3 to 3 bar.

25. The process for preparing an aminoplast solution according to claim 19, wherein apparatus B consists of at least two stirred tanks, the molar ratio of formaldehyde to urea in the first tank of apparatus B being set at 2.6:1 to 2.25:1 and then being lowered in a further tank of apparatus B, by addition of urea in solid or dissolved form, to 2.2:1 to 1.9:1.

26. The process for preparing an aminoplast solution according to claim 19, wherein apparatus B consists of at least three stirred tanks, the molar ratio of formaldehyde to urea in the first tank of apparatus B being set at 2.6:1 to 2.3:1, being lowered in a further tank of apparatus B, by addition of urea in solid or dissolved form, to 2.25:1 to 2.1:1, and being lowered in turn in a further tank of apparatus B to 2.05:1 to 1.9:1.

27. The process for preparing an aminoplast solution according to claim 19, wherein the addition of urea in d) is carried out in two or more steps.

28. The process for preparing an aminoplast solution according to claim 19, wherein the mixture is distilled before the final addition of urea and before the setting of the final molar ratio in d).

29. The process for preparing an aminoplast solution according to claim 19, wherein the amount of the addition of acid in apparatus B is selected such that the urea-formaldehyde resins prepared in the solution have a weight-average molecular weight M_{w} of 15,000 to 50,000 g/mol.

30. An aminoplast solution prepared by the process according to claim 19, wherein the aminoplast solution has a solids content of 50 to 80 wt %.

31. A method comprising mixing an aminoplast solution prepared by the process according to claim 19 with 0 to 20 wt % of additives as a binder, and producing lignocellulosic moldings.

32. A method comprising mixing an aminoplast solution prepared by the process according to claim 19 with 0 to 20 wt % of additives, and sheetlike gluing of wood.

33. A method comprising mixing an aminoplast solution prepared by the process according to claim 19 with 0 to 20 wt % of additives and producing a glue for producing chipboard panels.

34. A method comprising mixing an aminoplast solution prepared by the process according to claim 19 with 0 to 20 wt % of additives and producing a glue for producing fiberboard panels.

35. A method for producing fiberboard panels, which comprises, in a blowline process, injecting an aminoplast solution prepared by the process according to claim 19, into a fiber stream, which is moving at high velocity, after the defibration of wood in a refiner, and then carrying out drying.

36. A lignocellulosic molding produced by pressing 5 to 30 wt % of solid resin, relative to lignocellulosic material, and optionally curing agents under pressure at press temperatures from 120 to 250° C.
